(19) United States
(12) Patent Application Publication
(10) Pub. No.: US 2017/0049293 A1
(43) Pub. Date: Feb. 23, 2017

(54) Dishwashing Device for an Aircraft

(71) Applicant: LUFTHANSA TECHNIK AG, Hamburg (DE)

(72) Inventors: Karl-Heinz HAAS, Achstetten (DE); Peter HUBER, Setzingen (DE)

(21) Appl. No.: 15/030,551

(22) PCT Filed: May 12, 2015
(86) PCT No.: PCT/EP2015/060477

§ 371 Date: Apr. 19, 2016

(30) Foreign Application Priority Data
May 16, 2014 (DE) 10 2014 209 359.7

(51) Int. Cl. A47L 15/00; A47L 15/48; B64D 11/04; A47L 15/42

(52) U.S. Cl. CPC A47L 15/0076; A47L 15/4259; A47L 15/4217; A47L 15/488; B64D 11/04; A47L 2501/22; A47L 2401/09

(57) ABSTRACT

The present invention relates to a dishwashing device for an aircraft, comprising
an inner chamber, which receives crockery to be cleaned and cleaning medium, and
a door, which closes an opening in the inner chamber in a closed position, and
a connecting apparatus for connecting the dishwashing device to a water disposal system of the aircraft,
the door being secured in the closed position by means of at least one locking apparatus, wherein
the locking apparatus is designed to release the door from the closed position by a releasing movement when a predetermined pressure gradient between the inner chamber and surroundings of the dishwashing device is exceeded.

The invention relates to a dishwashing device for an aircraft having the features of the preamble of claim 1.

Dishwashing devices are generally known which are, however, only suitable to a limited extent for use in aircraft, in particular aeroplanes. Said dishwashing devices essentially comprise an inner chamber which can be opened and closed by a door. The inner chamber can be loaded with crockery and the crockery can be removed therefrom when the door is open. During the cleaning process, the dirty crockery is cleaned by applying a cleaning medium by means of various nozzles when the door is closed. Water having appropriate cleaning additives, for example liquid chemicals, clear-rinse agents and/or cleaning agents, is preferably used as a cleaning medium.

Using a dishwashing device in an aircraft involves the problem of the inner chamber of the dishwashing device, which is filled with cleaning medium during operation, having to be sealed from the surroundings in order to reliably prevent cleaning medium from escaping. “Surroundings” means the cabin of the aircraft in this context. In addition to sealing, the dishwashing device also has to be capable of equalising pressure fluctuations between the inner chamber of the dishwashing device and the surroundings. This is a problem in particular if the pressure in the cabin suddenly drops. If, in such a situation, the pressure between the inner chamber and the surroundings is not equalised rapidly enough, there is the risk that the dishwashing device will be destroyed by the overpressure in the inner chamber and that people are put at risk. It is therefore a particular challenge to both seal the inner chamber from the surroundings and, if there is a sudden drop in pressure in the surroundings, to reduce the pressure gradient between the inner chamber and the surroundings as rapidly as possible.

There is also the problem that the dishwashing device has to be connectable to the on-board water supply system and water disposal system by means of a connecting apparatus. The on-board water disposal system of an aircraft usually comprises a vacuum system, in which a negative pressure is formed in order to suck out the waste water. Therefore, it is necessary to produce an interface by means of which the dishwashing device can interact with the vacuum system and thus the amount of cleaning medium which is supplied to the water disposal system can be controlled. The vacuum system thus forms, in addition to the pressure in the cabin, additional ambient pressure conditions under which the dishwashing device has to be able to operate.

The problem addressed by the invention is to provide a dishwashing device for an aircraft in which the reliability and safety is increased under ambient pressure conditions which are typical of air travel.

According to the basic concept of the invention, to solve the problem it is proposed that the locking apparatus is designed to release the door from the closed position by a releasing movement when a predetermined pressure gradient between the inner chamber and surroundings of the dishwashing device is exceeded. In aircraft, in particular in passenger aircraft, a sudden drop in cabin pressure may occur during flight. A sudden drop in pressure is understood to be a drop in pressure which is not caused by the usual pressure fluctuations, for example by a moderate change in flight altitude which is typical for passenger transport. A sudden drop in pressure may for example be caused by damage to the outer skin of an aircraft. In particular, a sudden drop in pressure is understood to be a pressure reduction from 719 hPa to 144 hPa within 15 seconds. Preferably, a sudden drop in pressure is intended to mean a drop in pressure of more than 10 hPa per second, more preferably of more than 20 hPa per second, particularly preferably of more than 30 hPa per second. This pressure reduction refers to the surroundings, and it is assumed here that the pressure in the inner chamber remains substantially constant or the drop in pressure in the inner chamber has a time delay compared with the drop in pressure in the surroundings. In a closed chamber, such as in the inner chamber of the dishwashing device, the pressure equalisation with the surroundings does not take place at all, or takes place only with a time delay. In particular by sealing the dishwashing device, by means of which the cleaning medium is prevented from escaping during operation, the delay in the drop in pressure in the inner chamber of the dishwashing device is increased. A pressure gradient thus develops between the surroundings, that is to say the cabin, and the inner chamber of the dishwashing device, which can lead to the walls forming the inner chamber being destroyed. If a sudden drop in pressure occurs, a compressive force of approximately 40 to 50 kN acts on the inner surface of the door owing to the pressure gradient between the inner chamber and the surroundings. Using the solution according to the invention, the locking apparatus can be controlled by the pressure gradient between the surroundings and the inner chamber, such that the locking apparatus is released when a predetermined pressure gradient is exceeded. As a result, the door can be opened in a releasing movement, and this results in the gas flowing from the inner chamber into the surroundings. Preferably, the releasing movement is set such that it is possible to open the door in a controlled manner. By opening the door, which is preferably designed as a hinged door, a flow cross section which is large in relation to the volume of the inner chamber is suddenly opened, and as a result sufficiently rapid pressure equalisation between the inner chamber and the surroundings can be carried out. The dishwashing device is thus reliably prevented from being destroyed by the overpressure developing in the inner chamber if a sudden drop in pressure occurs in the surroundings.

Preferably, the releasing movement of the door is limited by an end stop of the locking apparatus. Owing to the large flow cross section which is already formed in the case of a small opening movement of the door, sufficiently rapid pressure equalisation is made possible. Starting from the closed position, the door carries out the releasing movement until the end stop limits the releasing movement of the door. By limiting the opening movement of the door, people that are in front of the dishwashing device can also be prevented from being injured and pieces of crockery can be prevented from being ejected from the dishwashing device. Preferably, the end stop is formed by a positive-fit element.

In the end stop position, it is preferable for the opening of the door to have a maximum gap width of 25 cm. Preferably, the maximum gap width is 15 cm at most, more preferably 5 cm at most, particularly preferably 2.5 cm at most. Preferably, in the end stop position, the minimum gap width is 1 mm, more preferably 3 mm and particularly preferably 5 mm. Preferably, the opening angle of the door is 35° at most, preferably between 0.5° and 5°, more preferably approximately 2.5°. The door opening to a limited extent thus makes it possible to release a sufficiently large flow cross section, so that a sufficiently rapid pressure equalisation can take place between the surroundings and the inner chamber. At the same time, by limiting the gap width or the opening angle, crockery can be reliably prevented from flying out of the inner chamber of the dishwashing device. Furthermore, passengers who are in front of the door of the dishwashing device are prevented from being injured owing to the low range of movement of the door.

More preferably, the locking apparatus has a connection which is releasable in a force-dependent manner for securing the door in a closed position. A connection which is releasable in a force-dependent manner can, for example, be formed by a frictional connection or by a connection which is releasable by material deformation. In the frictional connection, the connection is produced by adhesion or a retaining force between two opposing surfaces. A connection which is releasable by material deformation means connections which are releasable by elastic or plastic material deformations. This for example includes breaking a connection at a point provided for this purpose when a predetermined force is exceeded. The connection which is releasable in a force-dependent manner has to be designed to reliably maintain the connection up to a predetermined retaining force and to release the connection when the retaining force is exceeded. Preferably, the retaining force is between 5 and 60 kN, more preferably between 10 and 40 kN and particularly preferably between 20 and 30 kN.

Preferably, the locking apparatus comprises a locking plate and a locking pin, the locking pin engaging behind an undercut in the locking plate. The door of the dishwashing device can thus be secured by the locking apparatus during a normal cleaning operation of the dishwasher. The door is thus effectively prevented from being opened when this is not desired, for example in turbulent flight conditions in which accelerations are acting on the dishwashing device. Preferably, the locking pin can be moved out of and into the undercut by an actuating apparatus, for example by a handle.

Furthermore, it is proposed that the locking plate is secured on the housing and/or on the door by means of a securing mechanism, the locking plate being displaceably retained relative to the securing mechanism. Preferably, the displacement movement takes place substantially in parallel with the opening movement of the door. The locking plate is thus held in position by the securing mechanism. The locking plate only carries out a displacement movement relative to the securing mechanism when a predetermined force is exceeded which acts on the door owing to the overpressure in the inner chamber of the dishwashing device and is thus passed into the locking plate. The displacement movement is caused by a pivoting movement of the door. Owing to the small angle of movement, the displacement movement can be substantially considered to be linear. During the displacement movement, the locking pin remains connected to the undercut of the locking plate. In this case, the direction of the opening movement of the door is the movement direction of the portion of the door on which the locking plate acts.

Furthermore, it is advantageous for the securing mechanism to comprise a retaining means which has an adjustable retaining force and frictionally connects a portion of the locking plate to the housing and/or to the door. Preferably, the retaining means is formed by a screw which is tightened using a defined torque. Preferably, the locking plate comprises a slot, through which the screw is connected to the housing and/or to the door. The screw head thus presses the locking plate against the housing. Once the retaining force or adhesion thus acting between the locking plate and the housing and/or the door is overcome, the displacement movement takes place into an end stop position.

Preferably, in an end stop position, the locking plate is positively connected to the securing mechanism and thus prevents the door from opening further. Once the adhesion is overcome, a displacement movement is thus made possible, which is however limited in the end stop position by the positive connection of the locking plate to the securing mechanism. It can thus be ensured that the door is only opened as far as a certain angle. It is only possible to move the door into the completely open position when the locking pin is moved out of the undercut in the locking plate.

Furthermore, it is proposed that the locking apparatus is arranged such that an edge region of the door which is opposite a rotary shaft of the door and a corresponding region of the housing can be interconnected by said locking apparatus. This arrangement, according to the invention, of the locking apparatus ensures that the opening movement of the door results in an approximately linear displacement movement of the locking apparatus. In addition, a single locking apparatus can thus ensure reliable locking of the door.

It is further advantageous for a securing bolt to block the opening movement of the door at least in part. The securing bolt serves to secure the door against further movement in the end stop position. In addition to the locking apparatus, there is thus preferably a redundant securing mechanism in order to limit the opening movement of the door. This is advantageous in particular owing to the high forces which act on the door in the event of a sudden drop in pressure in the surroundings. Preferably, the axial movement of the securing bolt can be controlled by a locking magnet.

According to the invention, it is proposed that the door substantially completely seals the inner chamber from the surroundings in the closed position, a valve apparatus being provided for setting a pressure equalisation between the inner chamber and the surroundings. Completely sealing the door means that the cleaning medium cannot escape from the inner chamber during the cleaning process. However, a completely sealed door has the disadvantage that a pressure equalisation cannot take place between the inner chamber and the surroundings. Here, smaller pressure fluctuations are meant which do not result in the door being opened by the locking apparatus as in the event of a sudden drop in pressure in the surroundings. Smaller pressure gradients between the surroundings and the inner chamber are thus equalised by the valve apparatus. Preferably, in addition to pressure equalisation, the valve apparatus is also used for discharging condensate. More preferably, the valve apparatus is arranged on the surface of the base of the inner chamber.

It is advantageous for a connecting apparatus to be provided, said apparatus comprising a waste water tank which can be brought into flow connection with a vacuum system of the aircraft, it being possible for the waste water tank to be brought into flow connection with a washing tank by means of a connecting line. The washing tank is used to collect and treat the cleaning medium of the dishwashing device, for example by heating using a boiler, in order to then reuse said medium for cleaning the crockery. If the cleaning medium is no longer required for the cleaning process, it has to be supplied to the on-board water disposal system; here, this is generally a vacuum system. The cleaning medium is sucked out by the negative pressure prevailing in the vacuum system. In order that only a certain volume of cleaning medium is sucked out by the vacuum system, a defined amount of cleaning medium is firstly pumped into a waste water tank. The waste water tank is in flow connection with the vacuum system via an interface, such that when the vacuum system and the waste water tank are in free flow connection, only the volume of cleaning medium which is in the waste water tank is supplied to the vacuum system and thus to the water disposal system. The advantage of this arrangement is that a type of sluice is produced by the waste water tank, of which the flow connection can be disconnected from the rest of the cleaning medium lines of the dishwashing device, by means of which sluice the volume of cleaning medium which should be supplied to the water disposal system can be controlled.

It is further advantageous for a pump to be provided in the connecting line, the pump being designed to convey the cleaning medium from the washing tank to a portion of the connecting line which is higher than the washing tank. Preferably, a particle filter is arranged between the washing tank and the pump.

Preferably, the cleaning medium from the higher portion can be brought into flow connection with the lower waste water tank in a free-flowing manner. Owing to the gravitational effect, the cleaning medium is conveyed from the higher portion into the waste water tank. A hygienic line is thus connected between the waste water tank and the washing tank, whereby for example germs are prevented from getting into the inner chamber of the dishwashing device from the water disposal system of the aircraft and the crockery is thus prevented from being contaminated with germs.

It is further preferable for the higher portion to be able to be brought into flow connection with the waste water tank by means of a valve. The waste water tank can thus be uncoupled from the washing tank in terms of flow. When the valve is closed, not only the cleaning medium in the waste water tank but also the cleaning medium in the washing tank is prevented from getting into the water disposal system due to the negative pressure in the vacuum system.

In a further advantageous embodiment, the filling of the waste water tank with cleaning medium can be controlled depending on the fill level in the waste water tank and/or the washing tank. At least one fill-level sensor is therefore provided on the waste water tank and/or the washing tank to determine the fill level. Preferably, a first fill-level sensor is provided on the waste water tank and a second fill-level sensor is provided on the washing tank. Preferably, the first and the second fill-level sensor are each arranged on an ascending pipe, the ascending pipes being in flow connection with the waste water tank and the washing tank respectively. The cleaning medium is, for example, pumped from the washing tank into the waste water tank under the following conditions: the fill level in the waste water tank is below a defined threshold value and the fill level of the washing tank is above a defined threshold value. In addition, further control algorithms can be stored, in particular parameters of the washing program can be used as input variables of the control system.

The invention is explained in the following on the basis of preferred embodiments with reference to the accompanying drawings, in which:

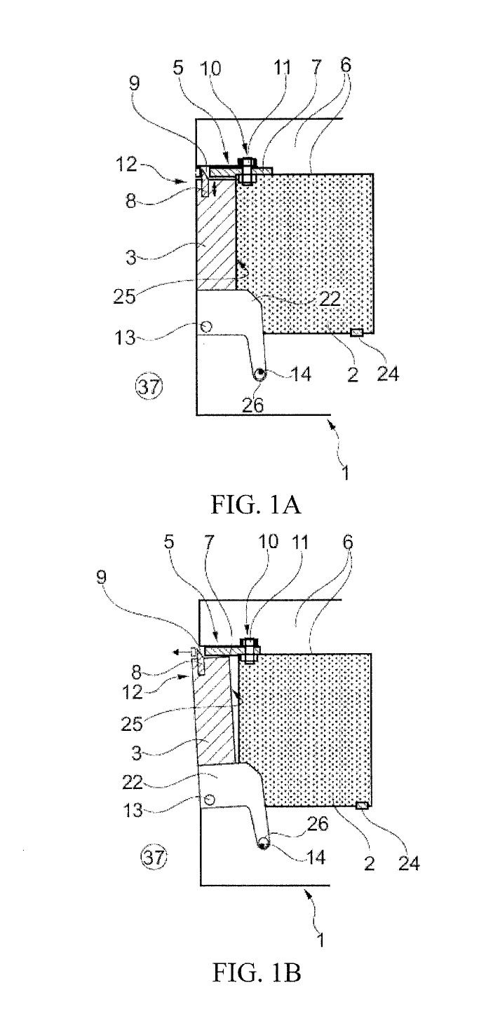

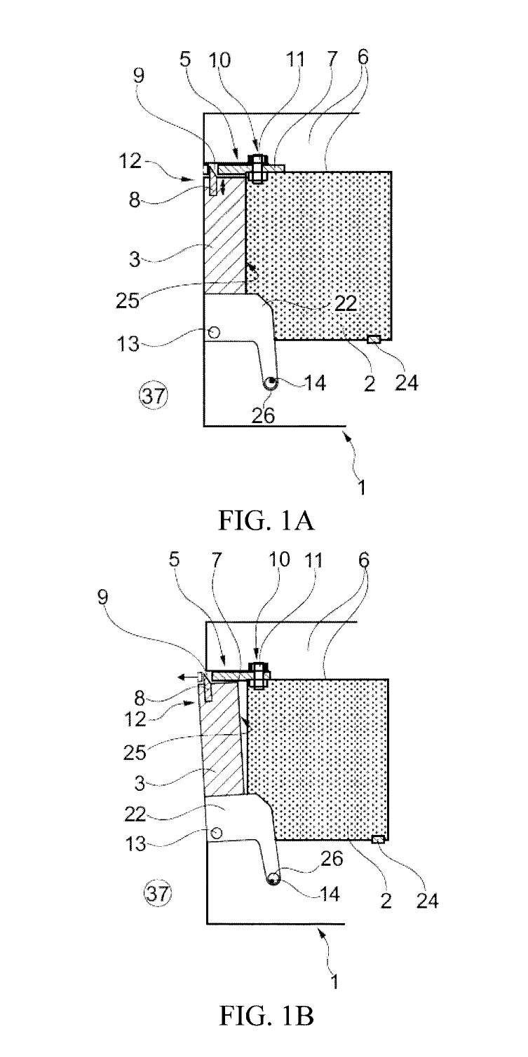

FIG. 1 is a schematic sectional view of a dishwashing device, having a door in a closed position (on the left) and in an end stop position (on the right);

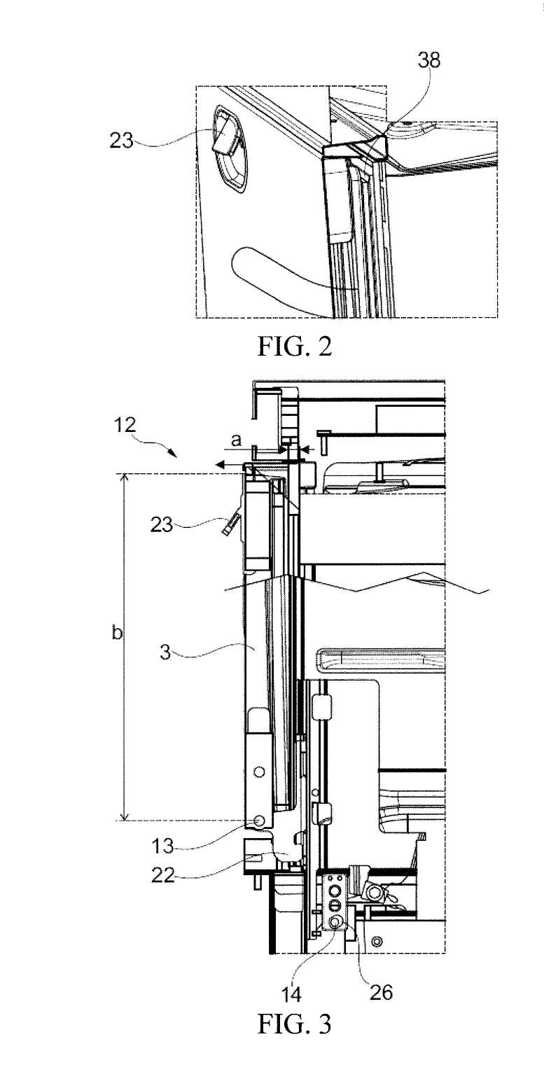

FIG. 2 is a perspective view of a dishwashing device, having a door in an end stop position;

FIG. 3 is a sectional view of a dishwashing device, having a door in an end stop position;

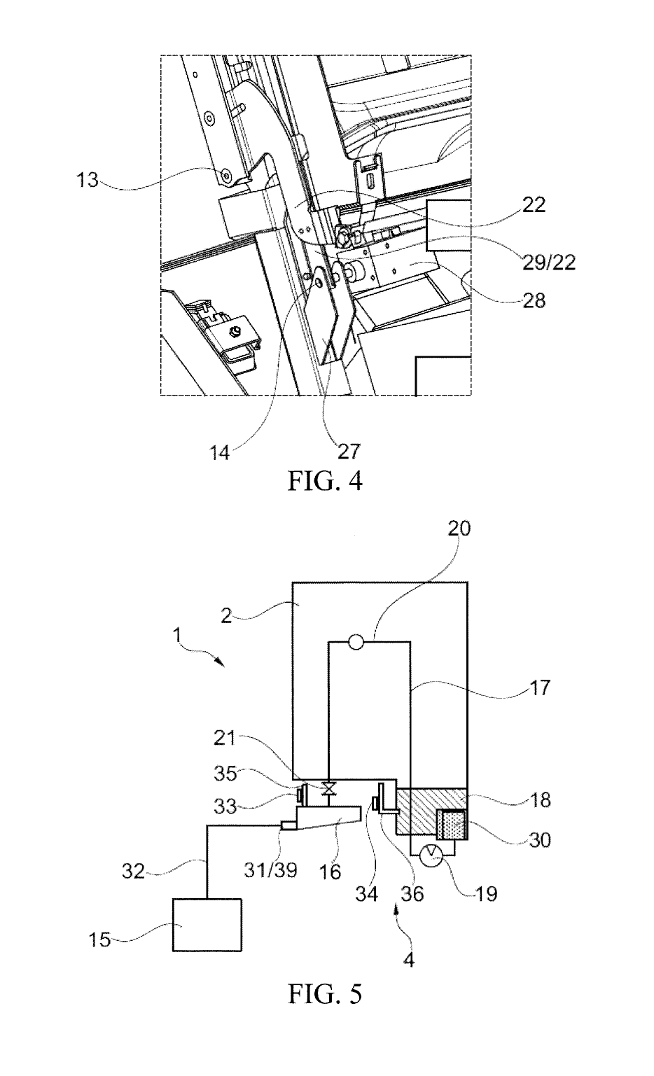

FIG. 4 is a detail of the dishwashing device in the region of a rotary shaft of the door; and

FIG. 5 is a schematic circuit diagram of a sub-system of a connecting apparatus.

FIG. 1 is a schematic sectional view of the essential mechanical construction of a dishwashing device 1. The dishwashing device 1 essentially comprises an inner chamber 2, a housing 6 surrounding the inner chamber 2, a door 3 and a locking apparatus 5. In an open position of the door 3, the inner chamber 2 is open and in a closed position of the door 3 the inner chamber 2 is closed. The door 3 is pivotally mounted about a rotary shaft 13, the door 3 being connected to the rotary shaft 13 by a hinged lever 22.

FIG. 1 further shows the locking apparatus 5 in detail. The locking apparatus 5 comprises a locking plate 7, a securing mechanism 10 and a locking pin 8. The locking plate 7 is connected to the housing 6 by the securing mechanism 10, which is preferably formed by a retaining means 11. The retaining means 11, which is preferably formed by a screw, frictionally connects the locking plate to the housing 6. The frictional connection is released when the retaining force or adhesion has been overcome, it being possible to preset the retaining force. If the retaining means 11 is formed by a screw, the retaining force can be set by the torque with which the screw is tightened. Here, the walls forming the inner chamber 2 can also be considered to be part of the housing 6. The retaining force which has to be overcome for a displacement movement of the locking plate 7 relative to the housing 6 can thus be set by the retaining means 11. The retaining means 11 is preferably guided through a slot in the locking plate 7, it being possible to define the maximum displacement movement of the locking plate 7 relative to the housing 6 by means of the length of the slot.

An undercut 9 is provided in the locking plate 7. In the closed position, the door 3 can be locked by the locking pin 8 engaging behind the undercut 9; the locking pin 8 is therefore positively connected to the locking plate 7. The locking pin 8 is arranged in an edge region 12 of the door 3 which is opposite the rotary shaft 13. Furthermore, the locking pin 8 is movable in the longitudinal axis thereof, the movement being adjustable along the longitudinal axis thereof, preferably by a handle 23 arranged on the outside of the door 3; see FIGS. 2 and 3.

The door 3 essentially moves in a pivoting movement about a rotary shaft 13. For this purpose, the door 3 is rotatably connected to the rotary shaft 13 by the hinged lever 22. In the closed position, the door 3 substantially completely seals the inner chamber 2 from the surroundings 37. In the various flight phases of the aircraft, the air pressure changes in the surroundings 37. Owing to the pressure gradient which develops between the surroundings 37 and the inner chamber 2, a force acts on the surfaces forming the inner chamber 2 which can lead to the dishwashing device 1 being destroyed under certain circumstances. A valve apparatus 24 is therefore provided which is used to reduce the pressure gradient. Owing to the small flow cross section of the valve apparatus 24, the pressure gradient can only be reduced under ambient pressure conditions which change slowly. In a preferred embodiment of the invention, the valve apparatus 24 is also used to conduct condensate forming in the inner chamber out of the inner chamber 2.

In the event of a sudden drop in pressure in the surroundings 37, the pressure gradient between the surroundings 37 and the inner chamber 2 can no longer be reduced sufficiently rapidly by means of the valve apparatus 24. A sudden drop in pressure is understood to be a drop in pressure which is not caused by the usual pressure fluctuations, for example by a moderate change in flight altitude which is typical for passenger transport. A sudden drop in pressure may for example be caused by damage to the outer skin of an aircraft. In particular, a sudden drop in pressure is understood to be a pressure reduction from 719 hPa to 144 hPa within 15 seconds. Preferably, a sudden drop in pressure is intended to mean a drop in pressure of more than 10 hPa per second, more preferably of more than 20 hPa per second, particularly preferably of more than 30 hPa per second. This pressure reduction refers to the surroundings 37, and it is assumed here that the pressure in the inner chamber 2 remains substantially constant or the drop in pressure in the inner chamber 2 has a time delay compared with the drop in pressure in the surroundings 37.

The locking apparatus 5 together with the securing mechanism 10 is therefore used to carry out a rapid and safe pressure equalisation between the inner chamber 2 and the surroundings 37. In the event of a sudden drop in pressure in the surroundings 37, an overpressure develops in the inner chamber 2. Pressure is therefore applied to an inner surface 25 of the door 3, which results in force acting in the direction of the arrow in FIG. 1 (on the right). Owing to the sudden drop in pressure in the surroundings 37, a delayed drop in pressure also occurs in the inner chamber 2 which results in hot water suddenly evaporating in the inner chamber 2, thereby producing an additional pressure increase in the inner chamber 2. Owing to the pressure gradient between the inner chamber 2 and the surroundings 37, a compressive force of approximately 40 to 50 kN acts on the inner surface 25 of the door 3.

In the embodiment in FIG. 1, the securing mechanism 10 is formed by the retaining means 11, the retaining means 11 preferably being formed by a screw. The locking plate 7 is frictionally connected to the housing 6 by the retaining means 11, such that a retaining force acts between the opposing surfaces of the locking plate 7 and of the housing 6. The retaining force defined by the retaining means 11 has to be great enough that the connection can be maintained until a predetermined compressive force is reached which acts on the inner surface 25 of the door 3. Preferably, the retaining force is between 5 and 60 kN, more preferably between 10 and 40 kN and particularly preferably between 20 and 30 kN. In this embodiment, the retaining force of the securing mechanism 10 is defined by the retaining force of the surfaces which are pressed against each other. Once the retaining force has been overcome, the locking plate 7 carries out a displacement movement in the direction of the arrow until it reaches an end stop position, which is shown on the right in FIG. 1. In this state, the locking pin 8 remains positively connected to the locking plate 7. The end stop position is defined by an end stop of the locking apparatus 5, the end stop being formed by the end region of a slot in the locking apparatus 5. The length of the slot in the locking plate 7 defines the end stop position.

In addition, a securing bolt 14 is provided to protect against the end stop position being exceeded, which bolt can be moved into a recess 26 in the hinged lever 22 in the longitudinal direction thereof; see also FIG. 3. The securing bolt 14 and the recess 26 are positioned outside the rotary shaft 13, so that the rotational movement and thus the opening angle of the door 13 can be limited. When moved into the recess 26, the securing bolt 14 rests on the recess 26 in a non-shape-corresponding manner, by means of which limited movement of the door 3 is made possible. Here, the recess 26 and the securing bolt 14 are dimensioned such that the door 3 can be moved out of the closed position and into the end stop position. In the end stop position, the door 3 is only opened widely enough for a sufficiently large flow cross section 38 to be produced, so that a sufficiently rapid reduction in the pressure gradient between the inner chamber 2 and the surroundings 37 can take place; see FIG. 2.

FIG. 3 shows the door 3 in the end stop position in which it is far enough moved towards the open position that the securing bolt 14 rests on an edge surface of the recess 26. In the edge region 12 of the door 3 facing the locking apparatus 5, the maximum gap width a is between 5 and 35 mm, preferably between 10 and 30 mm and more preferably approximately 20 mm. The length b of the door 3 is preferably between 400 and 500 mm, more preferably approximately 460 mm. This corresponds to an opening angle of the door 3 of preferably between 0.5° and 5°, more preferably approximately 2.5°. In addition to the locking apparatus 5, the securing bolt 14 forms a redundant stop for the end stop position. In a further embodiment, the securing bolt 14 can also be used to lock the door 3 in the completely closed position.

FIG. 4 is a perspective view of the region of the rotary shaft 13. The securing bolt 14 is mounted such that it is axially displaceable by a locking magnet 28. In the activated position thereof, the securing bolt 14 is supported by two locking elements 27, in order for it to be possible for the high forces to be absorbed in the event of a sudden drop in pressure in the surroundings 37. The securing bolt 14 is guided through the recess 26 in a receiving plate 29 between the locking elements 27, it being possible to consider the receiving plate 29 to be part of the hinged lever 22. The position of the securing bolt 14 is set by the locking magnet 28. Preferably, when the door 3 is closed, the securing bolt 14 is brought into the active position by the locking magnet 28. To open the door 3, the securing bolt 14 can then be moved into the deactivated position. The position of the securing bolt 14 can be controlled depending on the position of the handle 23, for example.

FIG. 5 is a schematic circuit diagram of a sub-system of a connecting apparatus 4; a sub-system, according to the invention, of the waste water disposal system is described in the following in this case. The connecting system includes the connection to the electronic supply of the aircraft, the fresh water supply and additional electronic interfaces, which for example are used for control and diagnosis. FIG. 5 shows the inner chamber 2 of the dishwashing device 1 according to the invention, in which chamber a cleaning medium is applied to the crockery. A washing tank 18 is arranged in a low region of the inner chamber 2, in which tank the cleaning medium collects and is treated for reuse, for example. Treating the cleaning medium includes heating using a boiler, for example.

The cleaning medium in the washing tank 18 can be pumped into a waste water tank 16 via a connecting line 17. The connecting line 17 has a portion 20 which is higher than the washing tank 18 and the waste water tank 16. A pump 19 is provided for the pumping process, a particle filter 30 preferably being connected between the pump 19 and the washing tank 18. Furthermore, the pump 19 is preferably arranged between the portion 20 and the washing tank 18. The cleaning medium can flow freely from the portion 20 into the waste water tank 16, provided that a valve 21 which is arranged in the connecting line 17, preferably directly upstream of the waste water tank 16, is open. In this context, a free flow connection is understood to be a flow connection in which the cleaning medium can flow unimpeded. Owing to the acting gravitational force, the cleaning medium can thus flow from the higher portion 20 into the waste water tank 16; the cleaning medium thus reaches the waste water tank 16 in free fall.

The waste water tank 16 is in flow connection with a vacuum system 15 of the aircraft by means of an interface 31 and a connecting line 32. The valve 21 is thus used to make it possible to uncouple the vacuum system 15 from the washing tank 18 depending on the valve position. If the valve 21 is in a closed position, then only the cleaning medium located in the waste water tank 16 can be sucked into the vacuum system. The waste water tank 16 preferably has a volume of 2 to 4 litres, more preferably of approximately 3 litres. The cleaning medium is thus prevented from being sucked out of the washing tank 18. Preferably, a valve 39 is provided in the interface 31, which valve interacts with the vacuum system 15 of the aircraft. Alternatively, the valve 39 may also be arranged outside the interface 31. Preferably, the valve 39 only opens if the waste water tank 16 is filled and the valve 21 is closed. It is thus ensured that only the contents of the waste water tank 16 are sucked out by the vacuum system 15.

The volume flow rate of cleaning medium from the washing tank 18 into the waste water tank 16 is essentially set by the pumping capacity of the pump 19. Here, the fill level of the waste water tank 16 and/or the fill level of the washing tank 18 are preferably used as input parameters for controlling the pumping capacity. The information on the fill level of the waste water tank 16 and of the washing tank 18 is determined by at least one fill-level sensor 33 and 34 respectively; preferably, the fill-level sensors 33 and 34 are formed by capacitive sensors. Advantageously, the fill-level sensors are each arranged in an ascending pipe 35 and 36; preferably, the ascending pipe is preferably made of plastics material. In a preferred embodiment, the ascending pipe 35 and/or the ascending pipe 36 is used as a ventilation pipe.

1-16. (canceled)

17. A dishwashing device for an aircraft, comprising:
a housing,
wherein the housing surrounds an inner chamber and has an opening between the inner chamber and a surrounding environment of the dishwashing device, and
wherein the inner chamber is configured to receive crockery to be cleaned and to receive a cleaning medium;
a door,
wherein when the door is in a closed position with respect to the housing, the door closes the opening between the inner chamber and the surrounding environment of the dishwashing device such that the door substantially completely seals the inner chamber from the surrounding environment of the dishwashing device through the opening;
a connector apparatus,
wherein the connector apparatus is configured to connect the dishwashing device to a water disposal system of an aircraft; and
a locking apparatus,
wherein the locking apparatus is configured to releasably secure the door in the closed position, such that when the locking apparatus is releasably securing the door is in the closed position, and a predetermined pressure gradient between an inner chamber pressure of the inner chamber and an external pressure of the surrounding environment of the dishwashing device is exceeded, the locking apparatus releases the door from the closed position via a releasing movement of the locking apparatus.

18. The dishwashing device according to claim 1,
wherein when the locking apparatus releases the door from the closed position via the releasing movement of the locking apparatus, an amount of movement of the door away from the closed position is limited by an end stop of the locking apparatus.

19. The dishwashing device according to claim 18,
wherein the amount of movement of the door away from the closed position is limited by the end stop of the locking apparatus such that a gap between the door and the housing has a maximum gap width of 25 mm.

20. The dishwashing device according to claim 18,
wherein the locking apparatus is configured to releasably secure the door in the closed position until a force applied by the door to the locking apparatus in a direction to push the door away from the closed position is greater than a threshold force, such when the force applied by the door to the locking apparatus in a direction to push the door away from the closed position is greater than the threshold force, the locking apparatus releases the door from the closed position via the releasing movement of the locking apparatus.

21. The dishwashing device according to claim 17,
wherein the locking apparatus comprises:
a locking plate,
wherein the locking plate has an undercut; and
a locking pin,
wherein the locking pin engages behind the undercut of the locking plate when the door is in the closed position.

22. The dishwashing device according to claim 21,
wherein the locking apparatus further comprises:
at least one securing mechanism,
wherein the at least one securing mechanism releasably displaceably secures the locking plate to the at least one securing mechanism such that:
(i) a first securing mechanism of the at least one securing mechanism is attached to the housing such that the first securing mechanism of the at least one securing mechanism releasably displaceably secures the locking plate to the housing;
(ii) a first securing mechanism of the at least one securing mechanism is attached to the door such that the first securing mechanism of the at least one securing mechanism releasably displaceably secures the locking plate to the door; or
(iii) a first securing mechanism of the at least one securing mechanism is attached to the housing such that the first securing mechanism of the at least one securing mechanism releasably displaceably secures the locking plate to the housing, and a second securing mechanism of the at least one securing mechanism is attached to the door such that the second securing mechanism of the at least one securing mechanism releasably displaceably secures the locking plate to the door.

23. The dishwashing device according to claim 22,
wherein the at least one securing mechanism comprises a corresponding at least one retainer,
wherein the at least one retainer applies a corresponding at least one adjustable retaining force to the locking plate so as to:
(i) frictionally connect the locking plate to the housing;
(ii) frictionally connect the locking plate to the door; or
(iii) frictionally connect the locking plate to the house and frictionally connect the locking plate to the door.

24. The dishwashing device according to claim 22,
wherein the amount of movement of the door away from the closed position is limited by the end stop of the locking apparatus when the end stop of the locking plate positively connects to the securing mechanism and thus prevents the door from opening further.

25. The dishwashing device according to claim 23,
wherein the amount of movement of the door away from the closed position is limited by the end stop of the locking apparatus when the end stop of the locking plate positively connects to the securing mechanism and thus prevents the door from opening further.

26. The dishwashing device according to claim 17,
wherein the door is rotates about a rotary shaft such that a first end of the door in nearer the rotary shaft than a second end of the door,
wherein the locking apparatus is arranged such that an edge region of the second end of the door and a corresponding region of the housing are interconnected by the locking apparatus when the door is in the closed position.

27. The dishwashing device according to claim 17, further comprising:
a securing bolt,
wherein the securing bolt limits the amount of movement of the door away from the closed position.

28. The dishwashing device according to claim 17, further comprising:
a valve apparatus,
wherein the door substantially completely seals the inner chamber from the surrounding environment of the dishwasher device when the door is in the closed position, and
wherein the valve apparatus interconnects the inner chamber and the surrounding environment of the dishwasher and is configured to reduce a pressure gradient between the inner chamber pressure of the inner chamber and the external pressure of the surrounding environment of the dishwasher device.

29. The dishwashing device according to claim 17,
wherein the connector apparatus comprises:
a waste water tank,
wherein the waste water tank is configured to be connected to a vacuum system of the water disposal system of the aircraft.

30. The dishwashing device according to claim 29, further comprising:
a washing tank,
wherein the waste water tank is configured to be brought into flow connection with the washing tank via a connecting line.

31. The dishwashing device according to claim 30,
wherein a pump is provided in the connecting line, and
wherein the pump is configured to convey the cleaning medium from the washing tank to a portion of the connecting line that is higher with respect to gravity than the washing tank.

32. The dishwashing device according to claim 31,
wherein the portion of the connecting line that is higher with respect to gravity than the washing tank is higher with respect to gravity than the waste water tank, and
wherein the cleaning medium in the portion of the connecting line that is higher with respect to gravity than the washing tank and higher with respect to gravity than the waste water tank is brought into flow connection with the waste water tank in a free-flowing manner.

33. The dishwashing device according to claim 32,
wherein the portion of the connecting line that is higher with respect to gravity than the washing tank and higher with respect to gravity than the waste water tank is brought into flow connection with the waste water tank via a valve.

34. The dishwashing device according to claim 31, wherein filling of the waste water tank with the cleaning medium is controlled depending on:
a waste water tank fill level in the waste water tank;
(ii) a washing tank fill level in the washing tank; or
(iii) a waste water tank fill level in the waste water tank and a washing tank fill level in the washing tank.

35. The dishwashing device according to claim 32, wherein filling of the waste water tank with the cleaning medium is controlled depending on:
(i) a waste water tank fill level in the waste water tank;
(ii) a washing tank fill level in the washing tank; or
(iii) a waste water tank fill level in the waste water tank and a washing tank fill level in the washing tank.

36. The dishwashing device according to claim 33,
wherein filling of the waste water tank with the cleaning medium is controlled depending on:
(i) a waste water tank fill level in the waste water tank;
(ii) a washing tank fill level in the washing tank; or
(iii) a waste water tank fill level in the waste water tank and a washing tank fill level in the washing tank.
